(19) United States
(12) Patent Application Publication
(10) Pub. No.: US 2002/0061369 A1
(43) Pub. Date: May 23, 2002

(54) Liquid crystal display and its manufacturing method

(75) Inventors: Miyuki Kunimatsu, Mobara (JP); Noboru Kunimatsu, Mobara (JP)

Correspondence Address: Stanley P. Fisher, Reed Smith Hazel & Thomas LLP, 3110 Fairview Park Drive, Suite 1400, Falls Church, VA, 22042-4503, US

(73) Assignee: Hitachi, Ltd.

(21) Appl. No.: 09/987,352

(22) Filed: Nov. 14, 2001

(30) Foreign Application Priority Data
Nov. 17, 2000 (JP) 2000-351320

(51) Int. Cl. C09K 19/00

(52) U.S. Cl. 428/1.5

(57) ABSTRACT

There are provided a liquid crystal display device and a manufacturing method therefor both of which is arranged to eliminate display irregularity in the vicinity of the liquid crystal injecting port of a liquid crystal panel and provide good display in the entire display area. In the liquid crystal panel, a lower substrate having thin film transistors for switching for pixel selection on its inside surface and an upper substrate having color filters for plural colors on its inside surface are disposed in opposition to each other with a layer of a liquid crystal compound being interposed therebetween, and the lower substrate and the upper substrate are stuck to each other by a sealing material which is arranged to surround a display area of the upper substrate and has, in a portion, a cut which serves as a liquid crystal injecting port. The liquid crystal injecting port is sealed with an end-sealing material after a liquid crystal compound has been injected through the liquid crystal injecting port, and the amount of constituent components of the end-sealing material which exist as impurities in the liquid crystal compound is 1.0/10,000 or less of the total peak area value of the liquid crystal compound that is measured by gas chromatography/mass spectrometry.

### BACKGROUND OF THE INVENTION

1. Field of the Invention

The present invention relates to a liquid crystal display device, and particularly, to a liquid crystal display device which restrains display irregularity near a liquid crystal injecting port of a liquid crystal panel which constitutes the liquid crystal display device, thereby realizing a far higher image quality.

2. Background Art

A liquid crystal display device basically uses a liquid crystal panel in which a liquid crystal is sealed between two substrates suitably made of glass substrates so that an image is displayed by using the fact that the polarization axis of the liquid crystal changes according to an electric field applied to the liquid crystal.

Switching elements such as thin film transistors for pixel selection and electrodes through which to supply driver signals to these respective switching elements are provided on at least either one of the two substrates (an upper substrate and a lower substrate) which constitute the liquid crystal panel.

The upper substrate and the lower substrate are stuck to each other by a sealing material which is arranged to surround a display area occupying the central large portion of each of the upper and lower substrates, and which has, in a portion, a cut which serves as the liquid crystal injecting port. After the liquid crystal has been injected through this liquid crystal injecting port, the liquid crystal injecting port is sealed with an end-sealing material. In general, the end-sealing material uses a light curing material compound, and is cured by irradiation with ultraviolet rays.

FIG. 12 is a schematic cross-sectional view showing a sealing portion of the liquid crystal panel. FIG. 13 is a plan view schematically showing the sealing portion and an end-sealing portion of the liquid crystal panel. In FIG. 12, sign SUB1 denotes a lower substrate on which thin film transistors are formed as switching elements, and sign SUB2 denotes an upper substrate on which color filters FIL are formed. Sign PASV denotes a passivation layer which constitutes an insulating layer, sign GL denotes a gate line through to supply a scanning signal to the thin film transistors (not shown), and sign GTM denotes a gate line lead terminal. Incidentally, multiple thin film transistors are formed in the display area surrounded by a sealing material SL. Although not shown, an alignment film is formed between a layer LC of a liquid crystal compound and each of the upper and lower substrates SUB1 and SUB2.

A black matrix BM, color filters FIL for three colors and an overcoat layer OC are formed on the inner surfaces of the upper substrate SUB2. Polarizers POL1 and POL2 are respectively stacked on the outside surfaces of both substrates.

As shown in FIG. 13, the sealing material SL is formed to extend along the periphery of the gap between the lower substrate SUB1 and the upper substrate SUB2 so as to seal the layer LC of a liquid crystal compound except the liquid crystal compound injecting port INJ and stick both substrates SUB1 and SUB2 to each other. After a liquid crystal compound has been injected, the liquid crystal injecting port INJ is sealed with an end-sealing material PLG.

This liquid crystal panel PNL is assembled by stacking various kinds of layers on each individual one of the lower substrate SUB1 and the upper substrate SUB2, forming the sealing material SL on the upper substrate SUB2, superposing the lower substrate SUB1 and the upper substrate SUB2 on each other, injecting the liquid crystal compound LC through the opening INJ which constitutes the liquid crystal injecting port for the sealing material SL, sealing the liquid crystal injecting port INJ with the end-sealing material PLG, and cutting both substrates SUB1 and SUB2 into shapes having predetermined sizes, respectively.

FIG. 14 is a process chart for explaining the outline of one example of a method of manufacturing a liquid crystal panel which constitutes a liquid crystal display device. The required thin films such as electrodes and color filters are formed on one substrate (an upper substrate) and the other substrate (a lower substrate) through separate processes. These two substrates are stuck to each other by a sealing material. The sealing material is inserted between the peripheries of the sticking inside surfaces of both substrates with an opening for injecting a liquid crystal compound (a liquid crystal injecting port) being left in a portion of one side of the gap between the substrates SUB1 and SUB2, whereby both substrates are stuck to each other by the sealing material (Process-1: hereinafter referred to as P-1).

Both substrates SUB1 and SUB2 are carried into a liquid crystal injecting chamber (in FIG. 14, referred to simply as “injecting chamber”), and is kept standby above a liquid crystal storage tank accommodated in the interior of the liquid crystal injecting chamber.

The whole of the liquid crystal storage tank or the liquid crystal injecting chamber is cooled at a predetermined temperature not higher than room temperature (the predetermined temperature changes according to the component of each individual liquid crystal material: a temperature at which the evaporation of the low molecular weight components of a liquid crystal material can be restrained).

During this state, the interior of the liquid crystal injecting chamber is pressure-reduced to, for example, a degree of vacuum of 1×10⁻¹ Torr to 1×10⁻⁵ Torr (P-3).

After the interior has been pressure-reduced to a predetermined value, the liquid crystal panel is descended to bring the liquid crystal injecting port into contact with the liquid crystal compound stored in the liquid crystal storage tank (P-4).

An intake control valve is opened with the liquid crystal injecting port of the liquid crystal panel being kept in contact with the liquid crystal material, and an inert gas is introduced into the interior of the liquid crystal injecting chamber to increase the pressure of the interior space (P-5). In this pressure-increasing process, the liquid crystal compound is injected into the interior of the liquid crystal panel.

The liquid crystal panel into which the liquid crystal compound has been injected is ascended by a carrying elevator mechanism, and after the liquid crystal injecting port has been separated from the liquid crystal compound, the liquid crystal panel is carried out of the liquid crystal injecting chamber (P-6).

An end-sealing material is applied to the liquid crystal injecting port of the liquid crystal panel which has been carried out of the liquid crystal injecting chamber (P-7), and is cured by irradiation with ultraviolet rays (P-8).

After that, the liquid crystal panel is loaded onto a hot press and is heated and pressed, followed by aging to form a predetermined cell gap and completely cure the sealing material and the end-sealing material (P-9). Thus, the liquid crystal panel is completed.

Incidentally, in the processing steps which follow P-7, it is also possible to adopt the sequence of forming the predetermined cell gap in the liquid crystal panel in which the liquid crystal material is injected into, by means of the press, then applying the end-sealing material to the liquid crystal injecting port, and then performing curing by ultraviolet irradiation. In addition, the number of liquid crystal panels to be carried into the liquid crystal injecting chamber is not limited to one at a time, and plural liquid crystal panels may be carried into the liquid crystal injecting chamber in batch fashion, and be processed at the same time. In addition, the liquid crystal material may also be injected before the liquid crystal panel is divided into unit panels.

Incidentally, a related art which relates to this kind of liquid crystal display device is disclosed in, for example, Japanese Patent Publication No. 13666/1976.

In the thin film transistor type of liquid crystal panel, the light absorption axes of the upper and lower polarizers shown in FIG. 12 are made to cross each other, and the liquid crystal panel is used in a so-called normally black mode in which black display is provided during non-display periods. In this case, during a low driving frequency, a display irregularity which looks white as shown in FIG. 13 may occur in the vicinity of the liquid crystal injecting port INJ. The reason for this is considered to be that the compound of the end-sealing material elutes into the liquid crystal compound.

When the liquid crystal compound of a related-art liquid crystal panel is sampled and analyzed by gas chromatography/mass spectrometry, the concentrations of the end-sealing material components are large in the vicinity of the liquid crystal injecting port compared to the central portion of a display area AR of the liquid crystal panel. The total concentration of the end-sealing material components in the vicinity of the liquid crystal injecting port is 1.5/10,000 or more with respect to the entire liquid crystal peak area. In contrast, the total concentration is 0.5 or less in the central portion of the display area AR.

It is inferred that this fact is the cause of display irregularity occurring in the vicinity of the liquid crystal injecting port INJ. However, no consideration has yet been given to countermeasures against such a defective display occurring in the vicinity of the liquid crystal injecting port INJ.

### SUMMARY OF THE INVENTION

An object of the invention is to provide a liquid crystal display device using a liquid crystal panel which is constructed to provide good display in the entire display area by restraining the occurrence of the above-described display irregularity, as well as a method of manufacturing such liquid crystal panel.

Representative examples of the construction of the liquid crystal display device according to the invention for achieving the above object and the method of manufacturing such liquid crystal display device will be described below.

The liquid crystal display device according to the invention includes a liquid crystal panel in which a lower substrate having thin film transistors for switching for pixel selection on its inside surface and an upper substrate having color filters for plural colors on its inside surface are disposed in opposition to each other with a layer of a liquid crystal compound being interposed therebetween, and the lower substrate and the upper substrate are stuck to each other by a sealing material which is arranged to surround a display area of the upper substrate and has, in a portion, a cut which serves as a liquid crystal injecting port, the liquid crystal injecting port being sealed with an end-sealing material after a liquid crystal compound has been injected through the liquid crystal injecting port. In such liquid crystal display device, the amount of constituent components of the end-sealing material which exist as impurities in the liquid crystal compound is made 1.0/10,000 or less of the total peak area value of the liquid crystal compound that is measured by gas chromatography/mass spectrometry.

The end-sealing material includes a methacrylic-group containing oligomer, one or more kinds of reactive dilution monomers, a photocrosslinked reaction initiator and a phenolic antioxidant, and the one or more kinds of reactive dilution monomers are any one or ones of those noted in Table 3 shown below, the photocrosslinked reaction initiator is any one of those expressed by Chemical Formulae 7 and 8(i) to 8(vi), and the phenolic antioxidant is any one of those expressed by Chemical Formulae 9(i) to 9(iii) noted below.

Table 3

Mono(meth)acrylic compounds such as methyl methacrylate, ethyl (meth)acrylate, a-butyl (meth)acrylate, 1-butyl (meth)acrylate, t-butyl (meth)acrylate, 2-ethylhexyl (meth)acrylate, lauryl (meth)acrylate, stearyl (meth)acrylate, cyclohexyl (meth)acrylate, benzyl (meth)acrylate, phenyl (meth)acrylate, phenoxyethyl (meth)acrylate, phenoxypropyl (meth)acrylate, 2-hydroxyethyl (meth)acrylate, 2-hydroxypropyl (meth)acrylate, 2-hydroxybutyl (meth)acrylate, 4-hydroxybutyl (meth)acrylate, glycidyl (meth)acrylate, tetrahydrofurfuryl (meth)acrylate, phenylglycidyl (meth)acrylate, dimethylaminoethyl (meth)acrylate, phenyl cellosolve (meth)acrylate, n-vinyl-2-pyrrolidone (meth)acrylate, dicyclobentinyl (meth)acrylate, biphenyl (meth)acrylate, glycidyl methacrylic (meth)acrylate and 2-hydroxyethyl (meth)acryloylphosphate; monovinyl compounds such as styrene, vinyltoluene, chlorostyren, divinylbenzene, 1-vinylnaphthalene and 2-vinylnaphthalene; and multifunctional methacrylic compounds such as ethylene glycol di(meth)acrylate, diethylene glycol di(meth)acrylate, triethylene glycol di(meth)acrylate, tetraethylene glycol di(meth)acrylate, nonaethylene glycol (meth)acrylate, 1,3-butylene glycol di(meth)acrylate, 1,4-Butanediol di(meth)acrylate, trimethylolpropane tri(meth)acrylate, neopentyl glycol diacrylate, 1,6-hexamethylene di(meth)acrylate, hydroxy pivalic acid ester neopenthyl glycol di(meth)acrylate, pentaerythritol tri(meth)acrylate, pentaerythritol tetra(meth)acrylate, dipentaerythritol hexa(meth)acrylate, and tris(meth)acryxyethyl isocyanurate.

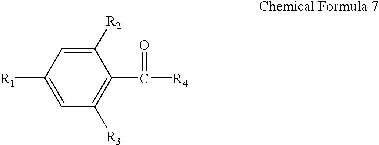

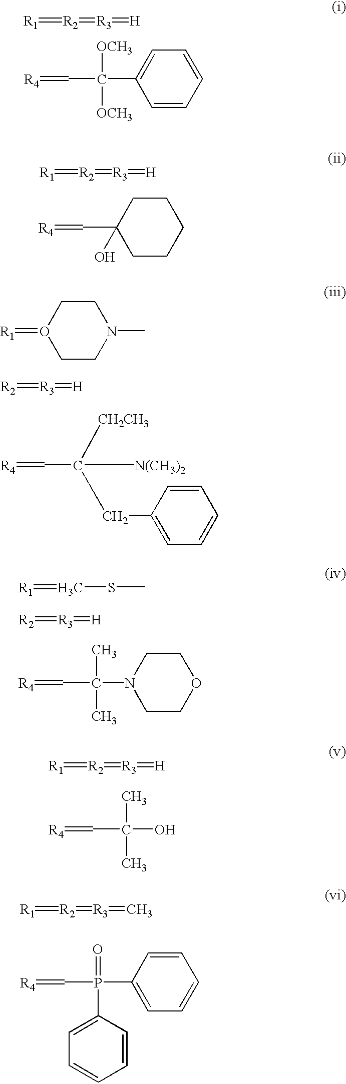

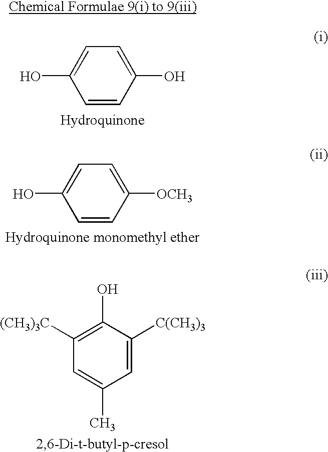

According to the liquid crystal display device using the liquid crystal panel having the above-described construction, it is possible to obtain a liquid crystal display device using a liquid crystal panel which is constructed to provide good display in the entire display area by restraining the occurrence of display irregularity in the vicinity of its liquid crystal injecting port.

The method of manufacturing a liquid crystal display device according to the invention includes the steps of: sticking an upper substrate and a lower substrate to each other by a sealing material which is arranged to surround a display area of the upper substrate and has, in a portion, a cut which serves as a liquid crystal injecting port; applying an end-sealing material to the liquid crystal injecting port after a liquid crystal compound has been injected through the liquid crystal injecting port, the end-sealing material containing any of the reactive dilution monomers noted in Table 4, a photocrosslinked reaction initiator expressed by any of Chemical Formulae 10 and 11(i) to 11(vi) and a phenolic antioxidant expressed by any of Chemical Formulae 12(i) to 12(iii); and curing the end-sealing material by irradiation with ultraviolet rays in an accumulated light quantity of 4,000 mJ/cm² or more and heating and aging the cured end-sealing material.

Table 4

Mono(meth)acrylic compounds such as methyl methacrylate, ethyl (meth)acrylate, a-butyl (meth)acrylate, 1-butyl (meth)acrylate, t-butyl (meth)acrylate, 2-ethylhexyl (meth)acrylate, lauryl (meth)acrylate, stearyl (meth)acrylate, cyclohexyl (meth)acrylate, benzyl (meth)acrylate, phenyl (meth)acrylate, phenoxyethyl (meth)acrylate, phenoxypropyl (meth)acrylate, 2-hydroxyethyl (meth)acrylate, 2-hydroxypropyl (meth)acrylate, 2-hydroxybutyl (meth)acrylate, 4-hydroxybutyl (meth)acrylate, glycidyl (meth)acrylate, tetrahydrofurfuryl (meth)acrylate, phenylglycidyl (meth)acrylate, dimethylaminoethyl (meth)acrylate, phenyl cellosolve (meth)acrylate, n-vinyl-2-pyrrolidone (meth)acrylate, dicyclobentinyl(meth)acrylate, biphenyl (meth)acrylate, glycidyl methacrylic (meth)acrylate and 2-hydroxyethyl (meth)acryloylphosphate; monovinyl compounds such as styrene, vinyltoluene, chlorostyren, divinylbenzene, 1-vinylnaphthalene and 2-vinylnathalene; and multifunctional methacrylic compounds such as ethylene glycol di(meth)acrylate, diethylene glycol di(meth)acrylate, triethylene glycol di(meth)acrylate, tetraethylene glycol di(meth)acrylate, nonaethylene glycol (meth)acrylate, 1,3-butylene glycol di(meth)acrylate, 1,4-Butanediol di(meth)acrylate, trimethylolpropane tri(meth)acrylate, neopentyl glycol diacrylate, 1,6-hexamethylene di(meth)acrylate, hydroxy pivalic acid ester neopenthyl glycol di(meth)acrylate, pentaerythritol tri(meth)acrylate, pentaerythritol tetra(meth)acrylate, dipentaerythritol hexa(meth)acrylate, and tris(meth)acryxyethyl isocyanurate.

Chemical Formula 10

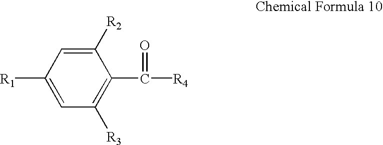

Chemical Formulae 8(i) to 8(vi)

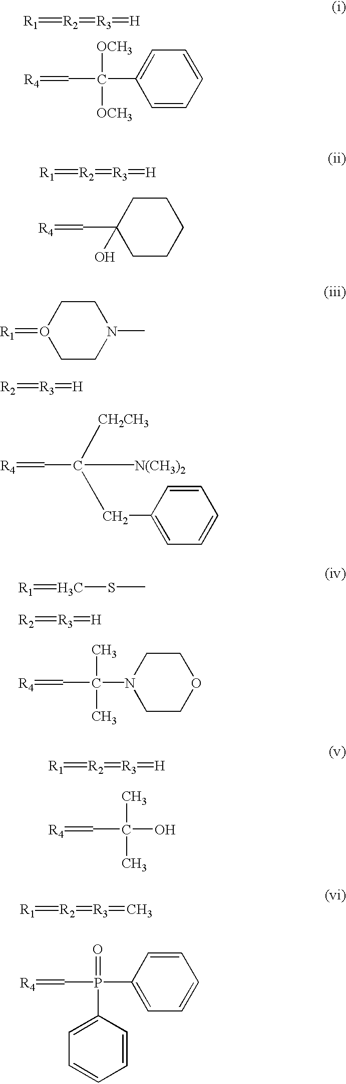

Chemical Formulae 12(i) to 12(iii)

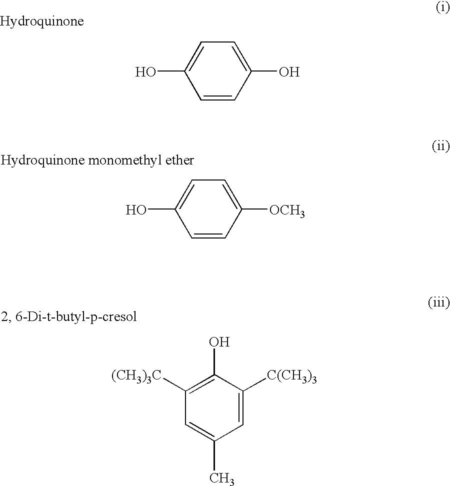

In addition, the amount of constituent components of the end-sealing material which exist as impurities in the liquid crystal compound after heating-and-aging processing is made 1.0/10,000 or less of the total peak area value of the liquid crystal compound that is measured by gas chromatography/mass spectrometry.

According to the above-described manufacturing method, it is possible to obtain a liquid crystal display device using a liquid crystal panel which is constructed to provide good display in the entire display area by restraining the occurrence of display irregularity in the vicinity of its liquid crystal injecting port.

The invention is not limited to the above-described construction nor the construction of any of embodiments which will be described later, and various modifications can be made without departing from the technical ideas of the invention.

### BRIEF DESCRIPTION OF THE DRAWINGS

The invention will become more readily appreciated and understood from the following detailed description of preferred embodiments of the invention when taken in conjunction with the accompanying drawings, in which:

FIG. 1 is a schematic plan view of a liquid crystal panel, for explaining a first embodiment of the liquid crystal display device according to the invention;

FIG. 2 is a schematic plan view of a liquid crystal panel, for explaining a second embodiment of the liquid crystal display device according to the invention;

FIG. 3 is an explanatory view of the measurement conditions of gas chromatography/mass spectrometry for quantifying the impurities of a liquid crystal compound in the invention;

FIG. 4 is an explanatory view of the total ion chromatogram of the liquid crystal compound in the central portion of the display area of a liquid crystal panel according to a related art;

FIG. 5 is an explanatory view of the total ion chromatogram of the liquid crystal compound in the vicinity of the liquid crystal injecting port of the liquid crystal panel according to the related art.

FIG. 6 is an explanatory view of the total ion chromatogram of a sample of an end-sealing material extracted by being melted with acetone;

FIG. 7 is an explanatory view of the relationship between an accumulated ultraviolet-light amount (mJ/cm²) and the amount of constituent components of an end-sealing material with respect to the peak area (10,000) of a liquid crystal compound;

FIG. 8 is an explanatory view of the relationship between the amount of impurities that eluded from the end-sealing material contained in the liquid crystal compound of the liquid crystal panel of each of the first and second embodiments of the invention and the resistivity of the liquid crystal compound;

FIG. 9 is a developed perspective view for explaining an example of the entire construction of a liquid crystal display device according to the invention;

FIG. 10 is a front view and a side view of a liquid crystal display module MDL;

FIG. 11 is a perspective view of a notebook type computer which is one example of electronic equipment in which a liquid crystal display device according to the invention is mounted;

FIG. 12 is a schematic cross-sectional view showing a sealing portion of the liquid crystal panel;

FIG. 13 is a plan view schematically showing the sealing portion and the end-sealing portion of the liquid crystal panel; and

FIG. 14 is a process chart for explaining the outline of one example of a method of manufacturing a liquid crystal panel which constitutes a liquid crystal display device.

### DETAILED DESCRIPTION OF THE INVENTION

Preferred embodiment of the invention will be described below in detail with reference to the accompanying drawings.

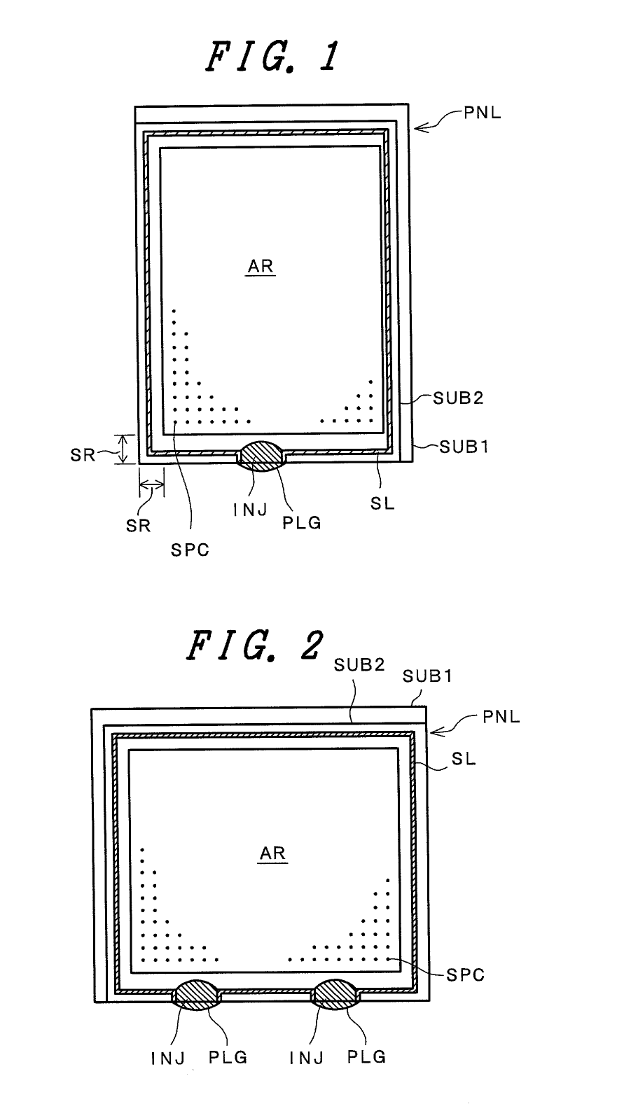

FIG. 1 is a schematic plan view of a liquid crystal panel, for explaining a first embodiment of the liquid crystal display device according to the invention. A liquid crystal panel PNL has a construction in which a layer of a liquid crystal compound interposed between a lower substrate SUB1 and an upper substrate SUB2 each made of a glass sheet and the lower substrate SUB1 and the upper substrate SUB2 are stuck to each other with a sealing material SL interposed therebetween in a sealing area SR provided in the periphery of a display area AR.

Each pixel of the liquid crystal panel PNL is disposed in an area of intersection of adjacent two gate lines and adjacent two drain lines which are formed on the inside surface of the lower substrate SUB1. Each pixel is made of a thin film transistor which is a switching element, a transparent pixel electrode (such as an ITO electrode), a charge-holding capacitance element and the like.

Such pixels are disposed in matrix form to constitute an active matrix substrate. The upper substrate SUB2 is used as a color filter substrate on which transparent common electrodes are formed together with color filters, a black matrix (light shielding film) and the like. This liquid crystal panel is of a so-called TN type.

On one shorter side of the liquid crystal panel PNL, a portion of the sealing material SL has a cut which forms a liquid crystal injecting port INJ. Protruding spacers SPC each formed by photolithographic processing with a resin material are fixedly formed on the lower substrate SUB1 or the upper substrate SUB2 in the display area AR. Incidentally, resin beads may be dispersively disposed in place of the spacers SPC.

An end-sealing material PLG for sealing the liquid crystal compound is applied to and cured in the liquid crystal injecting port INJ.

The amount of constituent components of the end-sealing material PLG which exist as impurities in the liquid crystal compound of the first embodiment is 1.0/10,000 or less of the total peak area value of the liquid crystal compound that is measured by gas chromatography/mass spectrometry.

FIG. 2 is a schematic plan view of a liquid crystal panel, for explaining a second embodiment of the liquid crystal display device according to the invention. This liquid crystal panel PNL has a comparatively large size, and two liquid crystal injecting ports INJ are formed on one longer side of the liquid crystal panel PNL, and the end-sealing material PLG is applied to and cured in each of the liquid crystal injecting ports INJ. The other construction is similar to that described above with reference to FIG. 1.

The amount of constituent components of the end-sealing material PLG which exist as impurities in the liquid crystal compound of the second embodiment is also 1.0/10,000 or less of the total peak area value of the liquid crystal compound that is measured by gas chromatography/mass spectrometry.

The end-sealing material PLG in each of the first and second embodiments includes a methacrylic-group containing oligomer, one or more kinds of reactive dilution monomers, a photocrosslinked reaction initiator and a phenolic antioxidant, and the one or more kinds of reactive dilution monomers are any one or ones of those noted in Table 5 shown below, the photocrosslinked reaction initiator is any one of those expressed by Chemical Formulae 13 and 14(i) to 14(vi), and the phenolic antioxidant is any one of those expressed by Chemical Formulae 15(i) to 15(iii) noted below.

Table 5

Mono(meth)acrylic compounds such as methyl methacrylate, ethyl (meth)acrylate, a-butyl (meth)acrylate, 1-butyl (meth)acrylate, t-butyl (meth)acrylate, 2-ethylhexyl (meth)acrylate, lauryl (meth)acrylate, stearyl (meth)acrylate, cyclohexyl (meth)acrylate, benzyl (meth)acrylate, phenyl (meth)acrylate, phenoxyethyl (meth)acrylate, phenoxypropyl (meth)acrylate, 2-hydroxyethyl (meth)acrylate, 2-hydroxypropyl (meth)acrylate, 2-hydroxybutyl (meth)acrylate, 4-hydroxybutyl (meth)acrylate, glycidyl (meth)acrylate, tetrahydrofurfuryl (meth)acrylate, phenylglycidyl (meth)acrylate, dimethylaminoethyl (meth)acrylate, phenyl cellosolve (meth)acrylate, n-vinyl-2-pyrrolidone (meth)acrylate, dicyclobentinyl(meth)acrylate, biphenyl (meth)acrylate, glycidyl methacrylic (meth)acrylate and 2-hydroxyethyl (meth)acryloylphosphate; monovinyl compounds such as styrene, vinyltoluene, chlorostyren, divinylbenzene, 1-vinylnaphthalene and 2-vinylnathalene; and multifunctional methacrylic compounds such as ethylene glycol di(meth)acrylate, diethylene glycol di(meth)acrylate, triethylene glycol di(meth)acrylate, tetraethylene glycol di(meth)acrylate, nonaethylene glycol (meth)acrylate, 1,3-butylene glycol di(meth)acrylate, 1,4-Butanediol di(meth)acrylate, trimethylolpropane tri(meth)acrylate, neopentyl glycol diacrylate, 1,6-hexamethylene di(meth)acrylate, hydroxy pivalic acid ester neopenthyl glycol di(meth)acrylate, pentaerythritol tri(meth)acrylate, pentaerythritol tetra(meth)acrylate, dipentaerythritol hexa(meth)acrylate, and tris(meth)acryxyethyl isocyanurate.

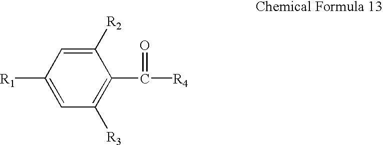

Chemical Formulae 14(i) to 14(vi)

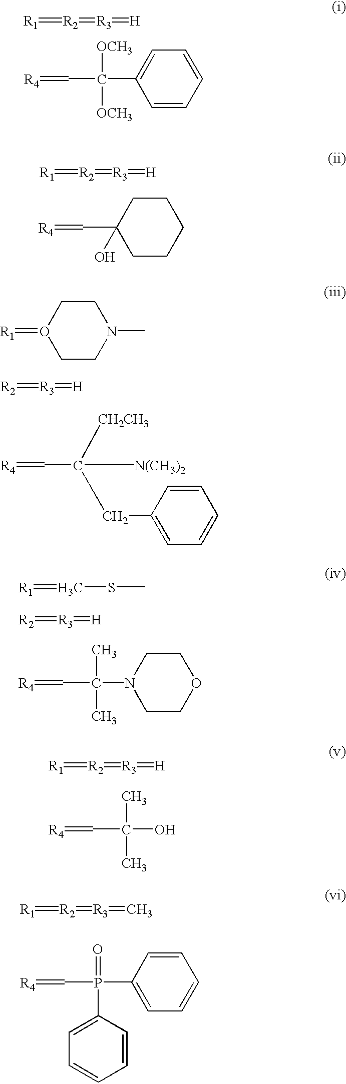

Chemical Formulae 15(i) to 15(iii)

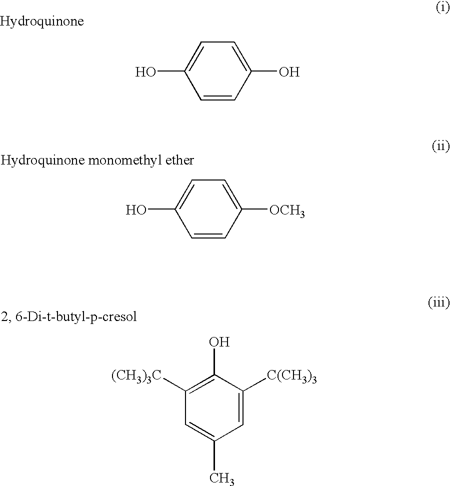

According to the liquid crystal display device using the liquid crystal panel having the above-described construction, it is possible to obtain a liquid crystal display device using a liquid crystal panel which is constructed to provide good display in the entire display area by restraining the occurrence of display irregularity in the vicinity of its liquid crystal injecting port(s). The quantification of such impurity components can make use of, for example, the following method.

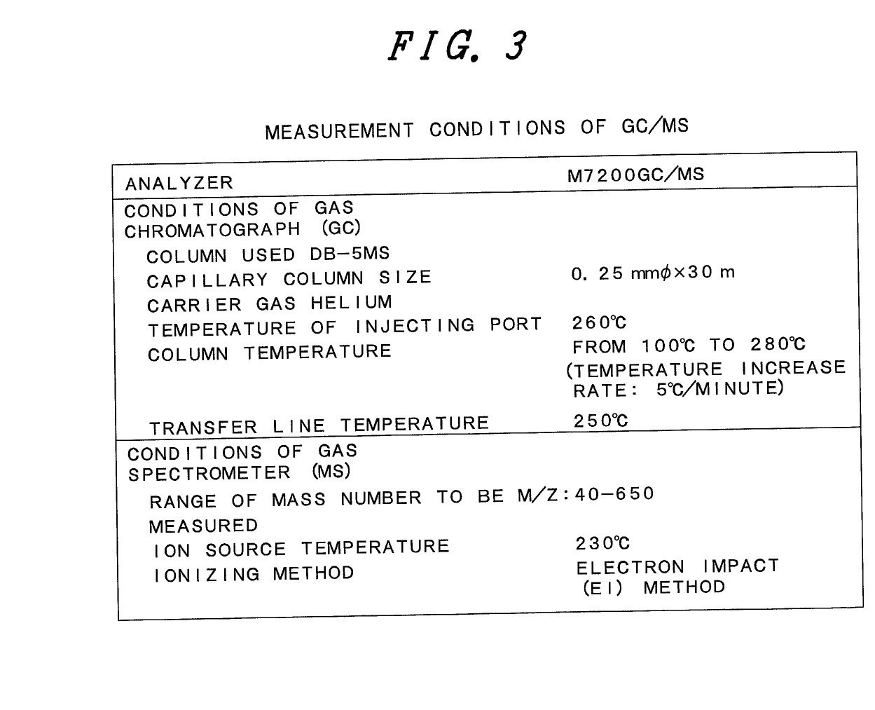

FIG. 3 is an explanatory view of the measurement conditions of gas chromatography/mass spectrometry for quantifying the impurities of a liquid crystal compound in the invention. The gas chromatography/mass spectrometer (GC/MS) used in the invention is M7200GC/MS made by Hitachi, Ltd.

The liquid crystal compound lying in the central portion of the display area of the liquid crystal panel PNL was sampled and was diluted to 1/1000 with acetone. The diluted sample was measured under the conditions shown in FIG. 3 in a sample injection amount of 1 μl (microlitter), whereby the component ratio of the liquid crystal material was found. Then, the liquid crystal compound lying in the vicinity of the liquid crystal injecting port was sampled and was measured under the same conditions.

In this case, since as dense a sample as possible is injected, almost all components of the constituent components of the liquid crystal compound show spectra which reach their maximum peaks. For this reason, from among the peaks of the constituent components of the liquid crystal compound, the smallest peak (a peak excluding the maximum peaks) was selected as an internal standard, and the area ratio of such peaks to impurity peaks was compared to determine the amount of impurities in the entire liquid crystal compound.

This measurement method enables detection of up to 1/1,000,000. Regarding samples A and B which were larger in display irregularity level in that order, the sample A contained about 20/1,000,000 (20 ppm) of impurities by peak area ratio, and the sample B contained about 50/1,000,000 (50 ppm) of impurities by peak area ratio.

According to an evaluation method for visual display irregularity, a liquid crystal panel free of display irregularity contained impurities in an amount smaller than 20/1,000,000.

The measurement result of the impurity concentration of the liquid crystal compound of a liquid crystal panel according to the invention will be described below in comparison with a liquid crystal panel according to a related art.

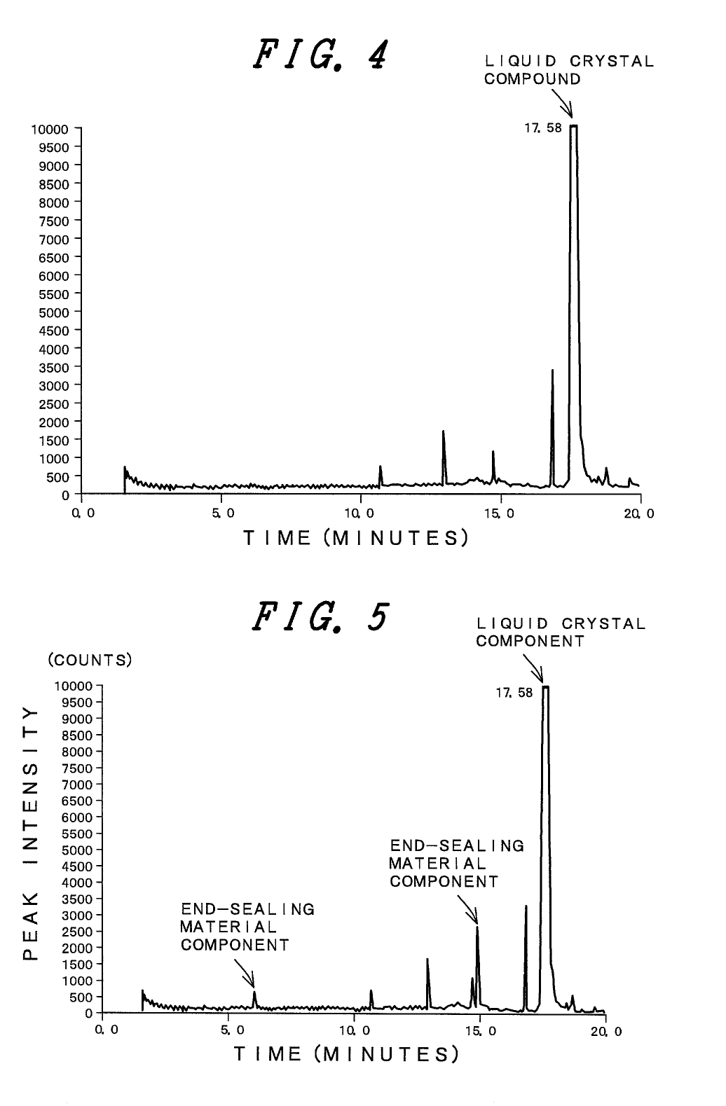

FIG. 4 is an explanatory view of the total ion chromatogram of the liquid crystal compound in the central portion of the display area of the liquid crystal panel according to the related art. FIG. 5 is an explanatory view of the total ion chromatogram of the liquid crystal compound in the vicinity of the liquid crystal injecting port of the liquid crystal panel according to the related art.

As can be seen from a comparison between the total ion chromatogram, shown in FIG. 5, of the liquid crystal compound in the central portion of the display area of the liquid crystal panel and that shown in FIG. 4, the peaks of impurity components occur at the points in measurement time of about 6 minutes and about 15 minutes. Incidentally, the sampling of the liquid crystal compound in a portion where display irregularity occurred was performed in the way of scraping off an end-sealing material at a location where the display irregularity occurred, and extracting a sample by melting the scraped end-sealing material with acetone.

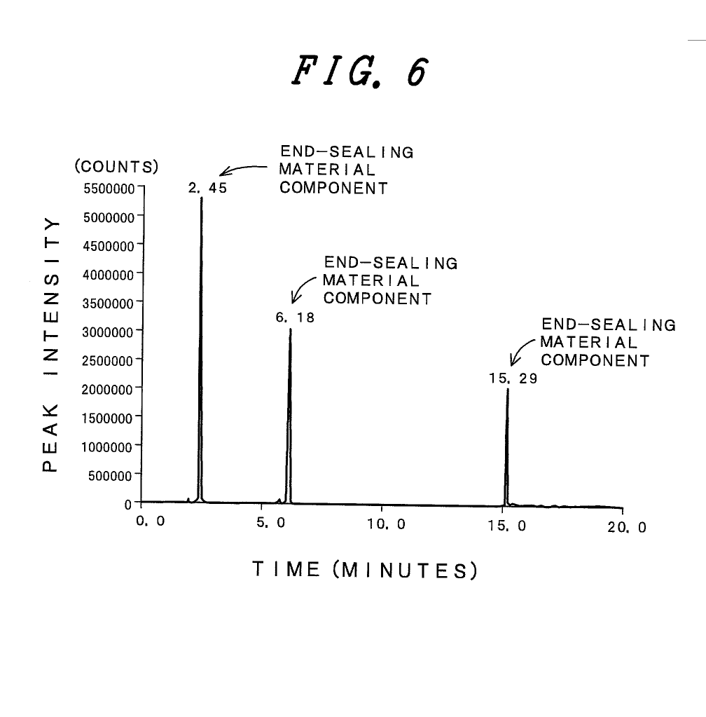

FIG. 6 is an explanatory view of the total ion chromatogram of the sample of the end-sealing material extracted by being melted with acetone. From this measurement result, it can be seen that the impurity components shown in FIG. 6 coincide with those shown in FIG. 5 in regard to the periods of measurement time required to detect their peaks and their mass spectra and these impurity peaks indicate constituent components of the end-sealing material.

An accumulated ultraviolet-light amount (mJ/cm²) during ultraviolet irradiation processing which is curing processing for an end-sealing material, and the amount by which the constituent components of the end-sealing material elude into a liquid crystal compound, will be described below.

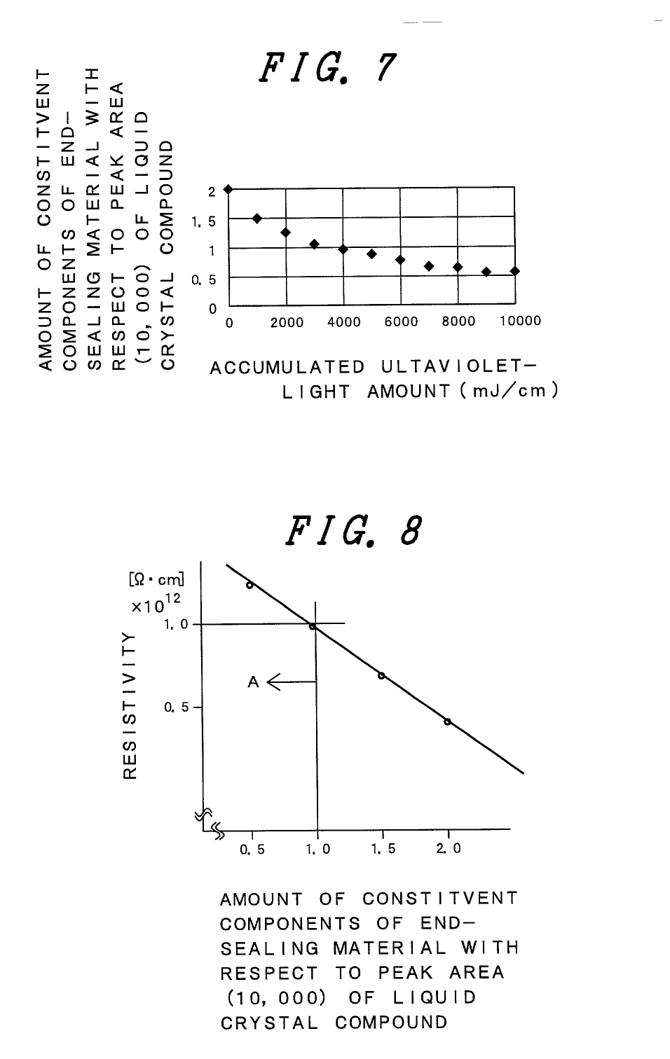

FIG. 7 is an explanatory view of the relationship between the accumulated ultraviolet-light amount (mJ/cm²) and the amount of the constituent components of the end-sealing material with respect to the peak area (10,000) of the liquid crystal compound. As shown in FIG. 7, when the accumulated ultraviolet-light amount irradiated onto the end-sealing material is 4,000 mJ/cm² or more, the amount of the constituent components of the end-sealing material relative to the peak area of the liquid crystal compound (10,000) becomes 1.0 or less.

In other words, if the accumulated amount of ultraviolet rays to be irradiated for curing after upper and lower substrates have been stuck to each other and a liquid crystal compound has been injected through a liquid crystal injecting port and an end-sealing material has been applied thereto is made 4,000 mJ/cm² or more, the amount of elution of the end-sealing material into the liquid crystal compound can be made 1.0/10,000 or less of the total peak area value of the liquid crystal compound that is measured by gas chromatography/mass spectrometry.

In this manner, it is possible to restrain the occurrence of display irregularity in the vicinity of the end-sealing material and provide image display of high quality.

The effect of restraint on display irregularity in relation to the resistivity of a liquid crystal compound will be described below.

FIG. 8 is an explanatory view of the relationship between the amount of impurities that eluded from the end-sealing material contained in the liquid crystal compound of the liquid crystal panel of each of the first and second embodiments of the invention and the resistivity of the liquid crystal compound.

In the case of liquid crystal compounds used in a TN type of liquid crystal panel, if their resistivities are 1.0×10¹² Ω·cm or less, there occurs display irregularity which causes portions displayed in half-tone (gray) to look white. FIG. 8 shows the result obtained by preparing plural liquid crystal panels in each of which the impurity components of its liquid crystal compound was at the above-described concentration, sampling the liquid crystal compound and measuring each of their display resistances by using a “liquid electrode cell made by Ando Electric Co., Ltd.”

As shown in FIG. 8, when the amount of impurities in the liquid crystal compound is 1.0 or less (the amount of the constituent components of the end-sealing material relative to the peak area (10,000) of the liquid crystal compound) is 1.0 or less, the resistivity does not become lower than 1.0×10¹² Ω·cm and display irregularity which looks white does not occur. Therefore, it can be understood that display irregularity can be restrained by accommodating the amount of impurities in the liquid crystal compound into the range indicated by an arrow A in FIG. 8.

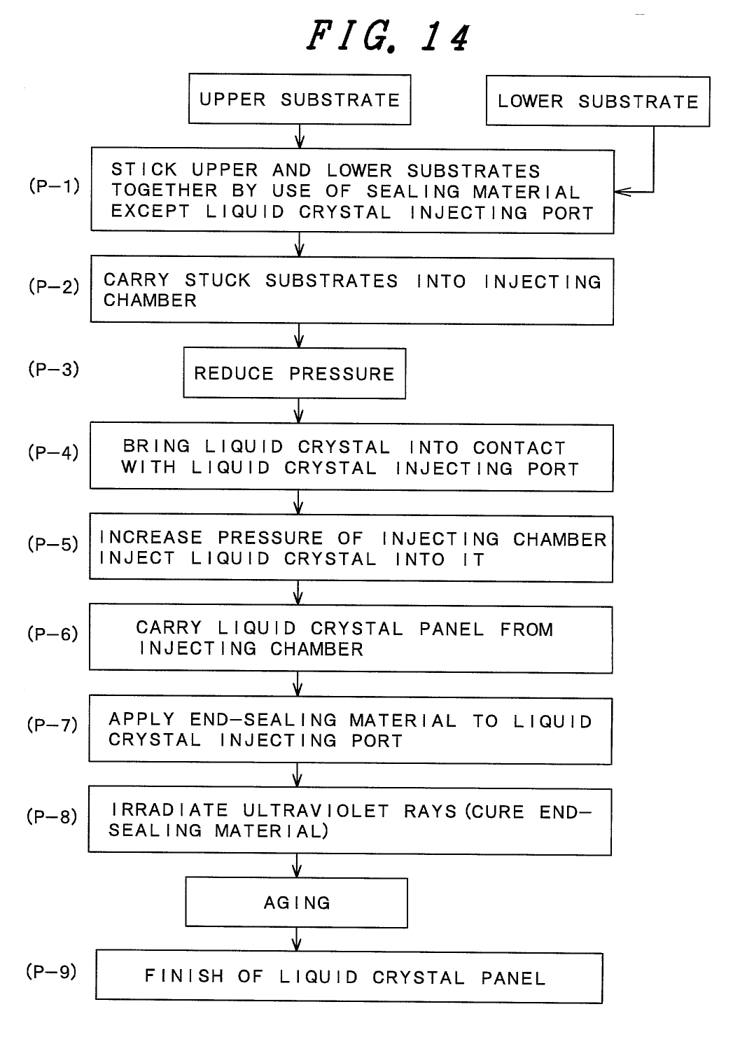

In a method of manufacturing a liquid crystal display device according to the invention, the accumulated ultraviolet-light amount is made 4,000 mJ/cm² or more in the ultraviolet irradiation process of the manufacturing process shown in FIG. 14, as described previously in connection with FIG. 7. The other processes of the manufacturing method according to the invention are similar to those shown in FIG. 14, and repetition of the same description is omitted.

Other constituent portions of the liquid crystal display device using the above-described liquid crystal panel as well as applied examples of such liquid crystal display device will be described below.

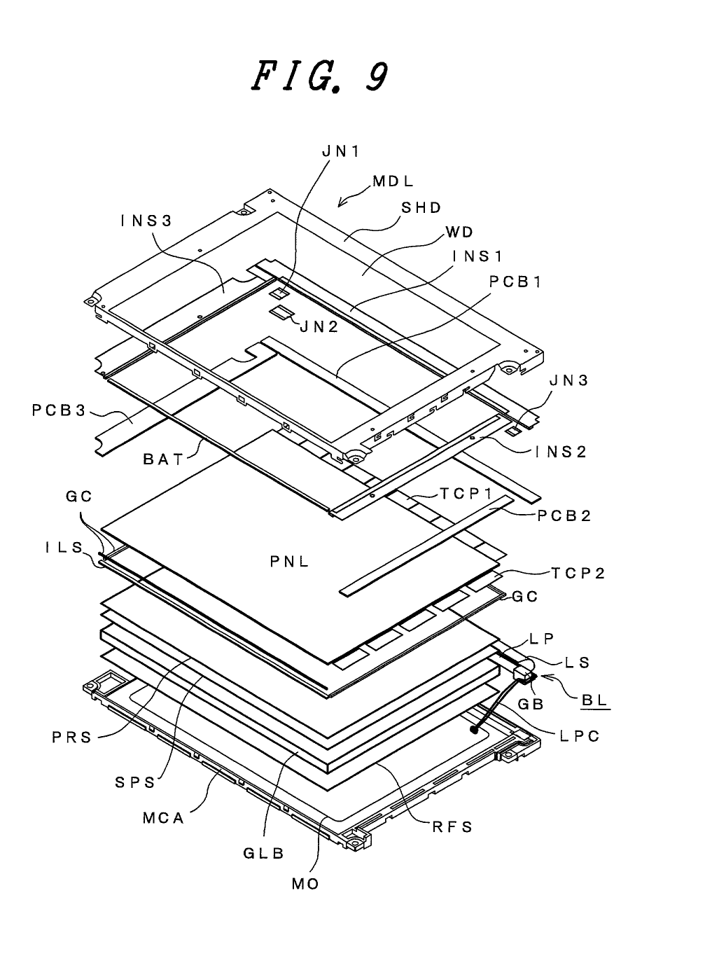

FIG. 9 is a developed perspective view for explaining an example of the entire construction of the liquid crystal display device according to the invention. FIG. 9 illustrates a specific structure of the liquid crystal display device (hereinafter referred to as the liquid crystal display module MDL in which are integrated a liquid crystal panel in which the lower substrates SUB1 and SUB2 are stuck to each other, driver means, a backlight and other constituent members).

In FIG. 9, sign SHD denotes a shield case (also called a metal frame) made from a metal plate, sign WD denotes a display window, signs INS1 to INS3 denote insulating sheets, signs PCB1 to PCB3 denote circuit boards which constitute the driver means (sign PCB1 denotes a drain side circuit board (a drain line driver circuit): a video signal line driving circuit board, sign PCB2 denotes a gate side circuit board (a gate line driver circuit board), and sign PCB3 denotes an interface circuit board), signs JN1 to JN3 denote joiners for electrically connecting the circuit boards PCB1 to PCB3 to one another, signs TCP1 and TCP2 denote tape carrier packages, sign PNL denotes a liquid crystal panel, sign GC denotes a rubber cushion, sign ILS denotes a light shield spacer, sign PRS denotes a prism sheet, sign SPS denotes a diffusing sheet, sign GLB denotes a light guide plate, sign RFS denotes a reflecting sheet, sign MCA denotes a lower case (a mold frame) formed by integrated molding, sign MO denotes an aperture of the lower case MCA, sign LP denotes a fluorescent lamp, sign LPC denotes a lamp cable, sign GB denotes a rubber bush which supports the fluorescent lamp LP, sign BAT denotes a double-faced adhesive tape, and sign BL denotes a backlight made of the fluorescent lamp LP, the light guide plate GLB and the like. The diffusing sheet members are stacked in the shown arrangement to assemble the liquid crystal display module MDL.

The liquid crystal display MDL has two kinds of accommodating/holding members, the lower frame MCA and the shield case SHD, and is constructed by joining the shield case SHD and the lower case MCA together. The insulating sheets INS1 to INS3, the circuit boards PCB1 to PCB3 and the liquid crystal display panel PNL are fixedly accommodated in the shield case SHD, while the backlight BL made of the fluorescent lamp LP, the light guide plate GLB, the prism sheet PRS and the like is accommodated in the lower case MCA.

An integrated circuit chip for driving the individual pixels of the liquid crystal display panel PNL is mounted on the video signal line driver circuit board PCB1. Mounted on the interface circuit board PCB3 are electronic circuits such as an integrated circuit chip for receiving video signals from an external host computer as well as control signals such as timing signals, and a timing converter TCON for processing timing and generating clock signals.

The clock signals generated by the timing converter are supplied to the integrated circuit chip which is mounted on the video signal line driver circuit board PCB1, via clock signal lines CLL which are formed on the interface circuit board PCB3 and the video signal line driver circuit board PCB1.

The interface circuit board PCB3 and the video signal line driver circuit board PCB1 are multi-layered wiring boards, and the clock signal lines CLL are formed as inner-layer lines of the interface circuit board PCB3 and the video signal line driver circuit board PCB1.

Incidentally, the drain side circuit board PCB1 for driving the TFTs, the gate side circuit board PCB2 and the interface circuit board PCB3 are connected to the liquid crystal panel PNL by the tape carrier packages TCP1 and TCP2, and the individual circuit boards are interconnected by the joiners JN1, JN2 and JN3. The liquid crystal panel PNL is of the TN type having the construction of any of the above-described embodiments.

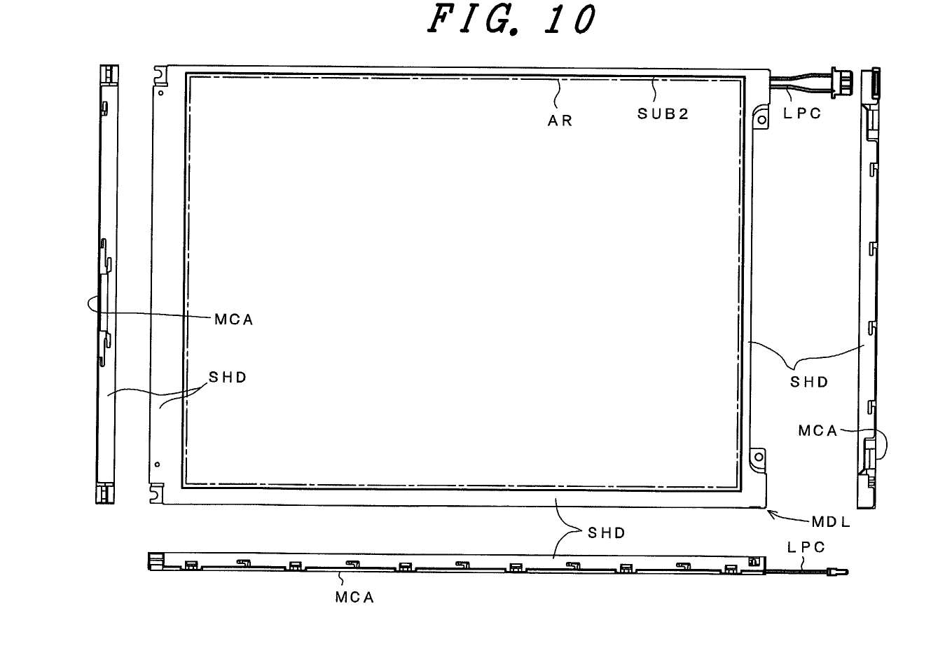

FIG. 10 is a front view and a side view of the liquid crystal display module MDL. The area exposed in the display window WD of the shield case SHD is an area (display area) AR in which to display an image, and a deflector is provided on the outermost surface of the area AR. The shield case SHD and the molded case MCA are secured to each other by the caulking of craws. The fluorescent tube LP which constitutes the backlight BL is accommodated in the interior of the upper side of the liquid crystal display module MDL, and lamp cables LPC for supplying electricity are led from the upper side. This liquid crystal display device (the liquid crystal display module MDL) is mounted in the display section of a display monitor or a personal computer.

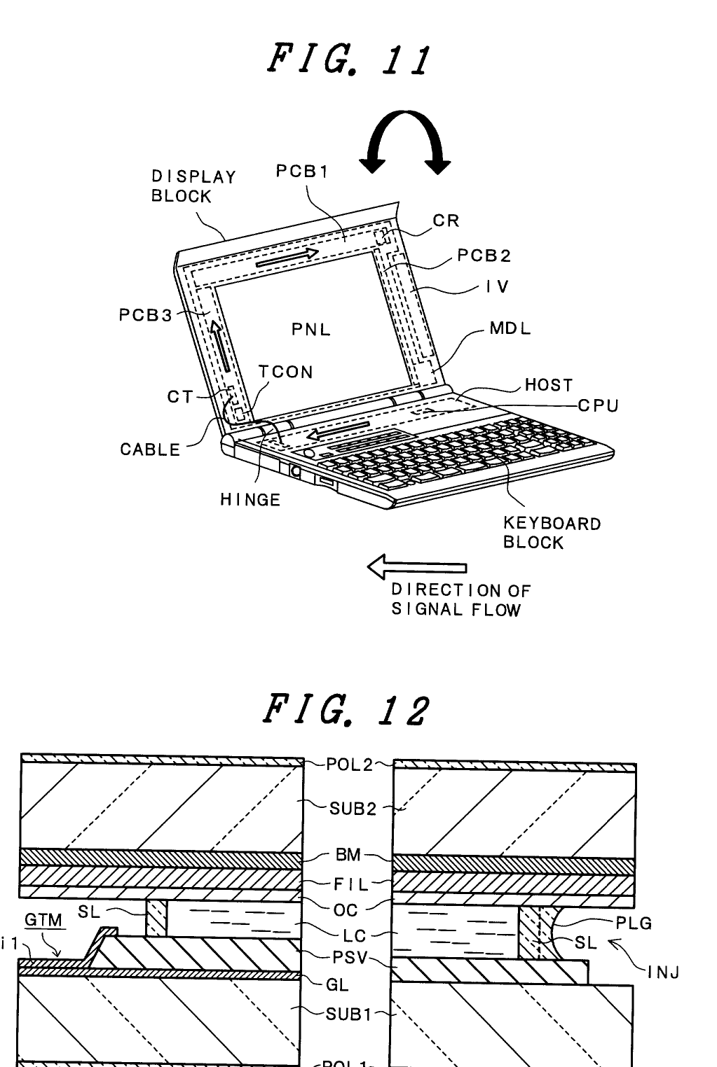

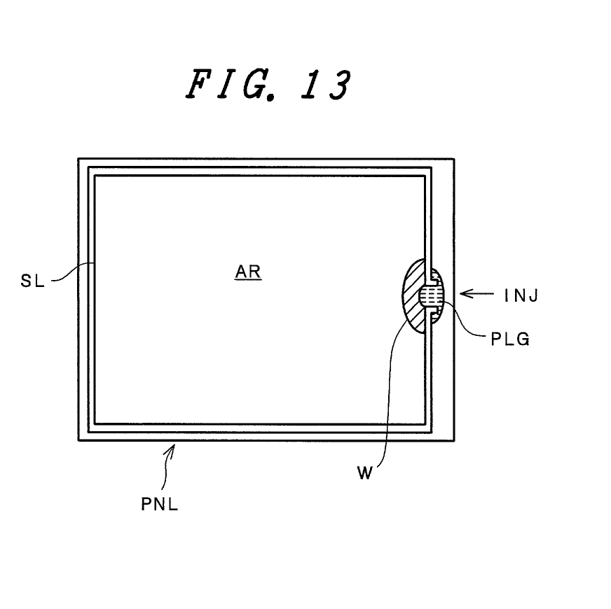

FIG. 11 is a perspective view of a notebook type computer which is one example of electronic equipment in which a liquid crystal display device according to the present invention is mounted. This notebook type computer (mobile personal computer) is made of a keyboard section (main-frame section) and a display section which is joined to the keyboard section by hinges. The keyboard section accommodates signal generating functions such as a keyboard, a host (host computer) and a CPU. The display section has the liquid crystal panel PNL, and the driver circuit boards PCB1 and PCB2, the driver circuit board PCB3 provided with the control chip TCON, and an inverter power source board which is a backlight power source are mounted at the periphery of the liquid crystal panel PNL.

The liquid crystal display module which is integrally provided with the above-described liquid crystal panel PNL, the various circuit boards PCB1, PCB2 and PCB3, the inverter power source board and the backlight is mounted in the notebook type computer.

According to any of the above-described embodiments, it is possible to provide a high-quality liquid crystal display device which can provide image display free of display irregularity in the entire display area.

As described hereinabove, according to the invention, it is possible to obtain a liquid crystal display device in which the occurrence of display irregularity is restrained in the vicinity of a liquid crystal injecting port which constitutes the liquid crystal display device, whereby good display is provided in the entire display area.

What is claimed is:

1. A liquid crystal display device comprising a liquid crystal panel in which a lower substrate having thin film transistors for switching for pixel selection on its inside surface and an upper substrate having color filters for plural colors on its inside surface are disposed in opposition to each other with a layer of a liquid crystal compound being interposed therebetween, and the lower substrate and the upper substrate are stuck to each other by a sealing material which is arranged to surround a display area of the upper substrate and has, in a portion, a cut which serves as a liquid crystal injecting port, the liquid crystal injecting port being sealed with an end-sealing material after a liquid crystal compound has been injected through the liquid crystal injecting port,
the amount of constituent components of the end-sealing material which exist as impurities in the liquid crystal compound is 1.0/10,000 or less of the total peak area value of the liquid crystal compound that is measured by gas chromatography/mass spectrometry.

2. A liquid crystal display device according to claim 1, wherein the end-sealing material includes a methacrylic-group containing oligomer, one or more kinds of reactive dilution monomers, a photocrosslinked reaction initiator and a phenolic antioxidant.

3. A liquid crystal display device according to claim 2, wherein the one or more kinds of reactive dilution monomers are any one or ones of those noted in Table 1 shown below, the photocrosslinked reaction initiator is any one of those expressed by Chemical Formulae 1 and 2(i) to 2(vi), and the phenolic antioxidant is any one of those expressed by Chemical Formulae 3(i) to 3(iii) noted below:
Table 1
Mono(meth)acrylic compounds such as methyl methacrylate, ethyl (meth)acrylate, a-butyl (meth)acrylate, 1-butyl (meth)acrylate, t-butyl (meth)acrylate, 2-ethylhexyl (meth)acrylate, lauryl (meth)acrylate, stearyl (meth)acrylate, cyclohexyl (meth)acrylate, benzyl (meth)acrylate, phenyl (meth)acrylate, phenoxyethyl (meth)acrylate, phenoxypropyl (meth)acrylate, 2-hydroxyethyl (meth)acrylate, 2-hydroxypropyl (meth)acrylate, 2-hydroxybutyl (meth)acrylate, 4-hydroxybutyl (meth)acrylate, glycidyl (meth)acrylate, tetrahydrofurfuryl (meth)acrylate, phenylglycidyl (meth)acrylate, dimethylaminoethyl (meth)acrylate, phenyl cellosolve (meth)acrylate, n-vinyl-2-pyrrolidone (meth)acrylate, dicyclobentinyl(meth)acrylate, biphenyl (meth)acrylate, glycidyl methacrylic (meth)acrylate and 2-hydroxyethyl (meth)acryloylphosphate; monovinyl compounds such as styrene, vinyltoluene, chlorostyren, divinylbenzene, 1-vinylnaphthalene and 2-vinylnaphthalene; and multifunctional methacrylic compounds such as ethylene glycol di(meth)acrylate, diethylene glycol di(meth)acrylate, triethylene glycol di(meth)acrylate, tetraethylene glycol di(meth)acrylate, nonaethylene glycol (meth)acrylate, 1,3-butylene glycol di(meth)acrylate, 1,4-Butanediol di(meth)acrylate, trimethylolpropane tri(meth)acrylate, neopentyl glycol diacrylate, 1,6-hexamethylene di(meth)acrylate, hydroxy pivalic acid ester neopenthyl glycol di(meth)acrylate, pentaerythritol tri(meth)acrylate, pentaerythritol tetra(meth)acrylate, dipentaerythritol hexa(meth)acrylate, and tris(meth) acryxyethyl isocyanurate.
Chemical Formula 1 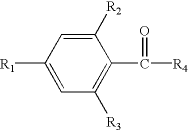
Chemical Formulae 2(i) to 2(vi) 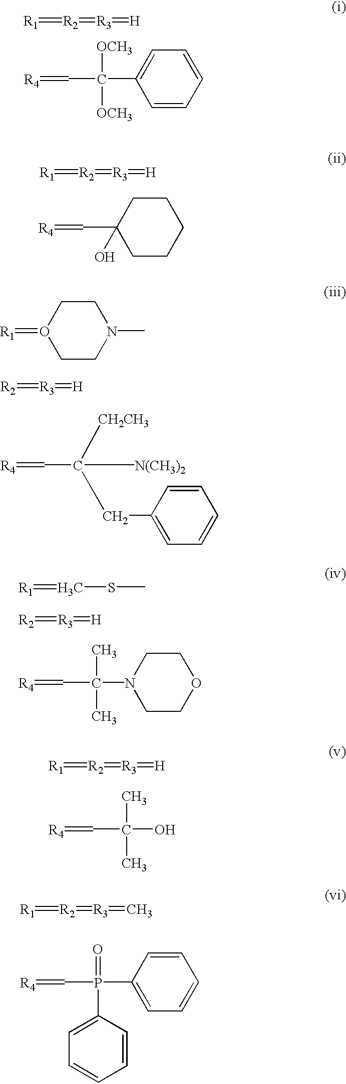
Chemical Formulae 3(i) to 3(iii)

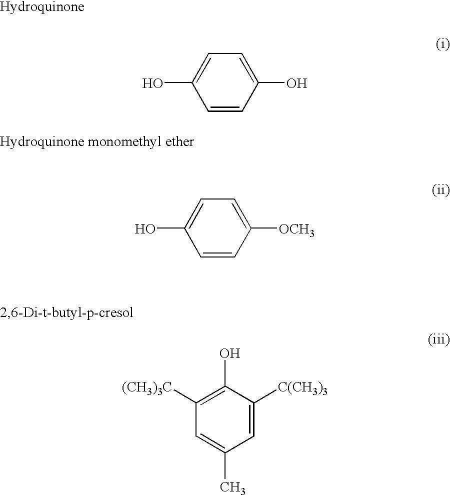

4. A method of manufacturing a liquid crystal display device including a liquid crystal panel in which a lower substrate having thin film transistors for switching for pixel selection on its inside surface and an upper substrate having color filters for plural colors on its inside surface are disposed in opposition to each other with a layer of a liquid crystal compound being interposed therebetween, comprising the steps of:
sticking the upper substrate and the lower substrate to each other by a sealing material which is arranged to surround a display area of the upper substrate and has, in a portion, a cut which serves as a liquid crystal injecting port;
applying an end-sealing material to the liquid crystal injecting port after the liquid crystal compound has been injected through the liquid crystal injecting port, the end-sealing material containing a reactive dilution monomer noted in Table 2, a photocrosslinked reaction initiator expressed by any of Chemical Formulae 4 and 5(i) to 5(vi) and a phenolic antioxidant expressed by any of Chemical Formulae 6(i) to 6(iii); and
curing the end-sealing material by irradiation with ultraviolet rays in an accumulated light quantity of 4,000 mJ/cm² or more and heating and aging the cured end-sealing material:
Table 2
Mono(meth)acrylic compounds such as methyl methacrylate, ethyl (meth)acrylate, a-butyl (meth)acrylate, 1-butyl (meth)acrylate, t-butyl (meth)acrylate, 2-ethylhexyl (meth)acrylate, lauryl (meth)acrylate, stearyl (meth)acrylate, cyclohexyl (meth)acrylate, benzyl (meth)acrylate, phenyl (meth)acrylate, phenoxyethyl (meth)acrylate, phenoxypropyl (meth)acrylate, 2-hydroxyethyl (meth)acrylate, 2-hydroxypropyl (meth)acrylate, 2-hydroxybutyl (meth)acrylate, 4-hydroxybutyl (meth)acrylate, glycidyl (meth)acrylate, tetrahydrofurfuryl (meth)acrylate, phenylglycidyl (meth)acrylate, dimethylaminoethyl (meth)acrylate, phenyl cellosolve (meth)acrylate, n-vinyl-2-pyrrolidone (meth)acrylate, dicyclobentinyl(meth)acrylate, biphenyl (meth)acrylate, glycidyl methacrylic (meth)acrylate and 2-hydroxyethyl (meth)acryloylphosphate; monovinyl compounds such as styrene, vinyltoluene, chlorostyren, divinylbenzene, 1-vinylnaphthalene and 2-vinylnathalene; and multifunctional methacrylic compounds such as ethylene glycol di(meth)acrylate, diethylene glycol di(meth)acrylate, triethylene glycol di(meth)acrylate, tetraethylene glycol di(meth)acrylate, nonaethylene glycol (meth)acrylate, 1,3-butylene glycol di(meth)acrylate, 1,4-Butanediol di(meth)acrylate, trimethylolpropane tri(meth)acrylate, neopentyl glycol diacrylate, 1,6-hexamethylene di(meth)acrylate, hydroxy pivalic acid ester neopenthyl glycol di(meth)acrylate, pentaerythritol tri(meth)acrylate, pentaerythritol tetra(meth)acrylate, dipentaerythritol hexa(meth)acrylate, and tris(meth)acryxyethyl isocyanurate.
Chemical Formula 4 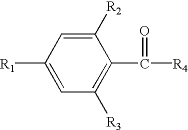
Chemical Formulae 5(i) to 5(vi) 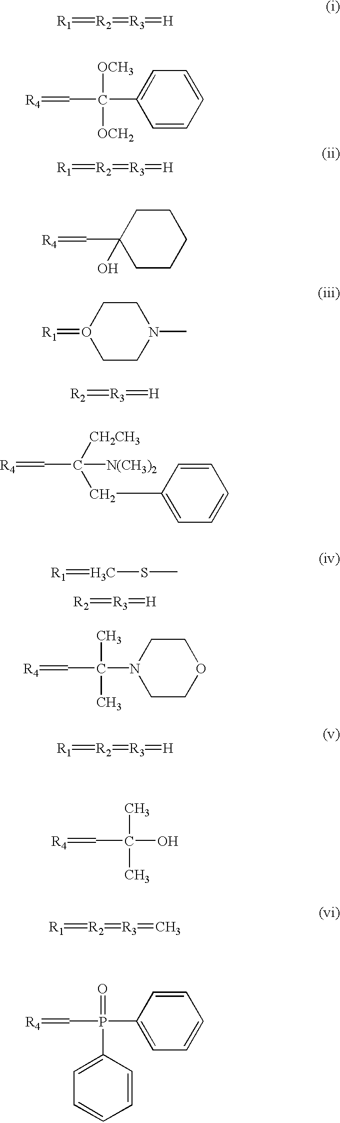
Chemical Formulae 6(i) to 5(iii)

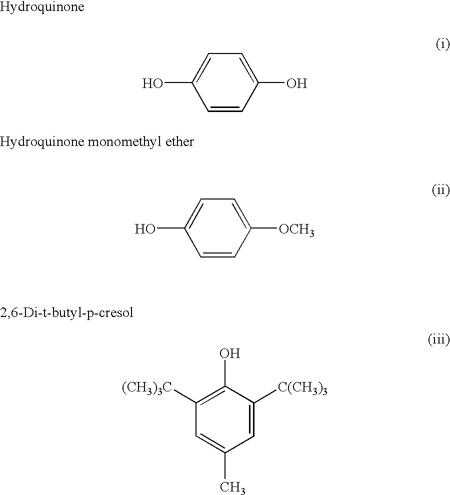

5. A method of manufacturing a liquid crystal display device according to claim 4, wherein the amount of constituent components of the end-sealing material which exist as impurities in the liquid crystal compound after the heating-and-aging step is 1.0/10,000 or less of the total peak area value of the liquid crystal compound that is measured by gas chromatography/mass spectrometry.
